(19) United States
(12) Patent Application Publication
(10) Pub. No.: US 2008/0270000 A1
(43) Pub. Date: Oct. 30, 2008

(54) Preventive-Action Protection System in a Motor Vehicle

(76) Inventor: Werner Bernzen, Ehningen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/667,387

(22) PCT Filed: Nov. 8, 2005
(86) PCT No.: PCT/EP05/11915

§ 371 Date: Jul. 17, 2008

(30) Foreign Application Priority Data
Nov. 10, 2004 (EP) PCT/EP2004/012685
Dec. 24, 2004 (DE) 10 2004 062 487.9

(51) Int. Cl. B60R 16/02; B60R 21/01; B60T 7/12; B60T 17/18

(52) U.S. Cl. 701/79

(57) ABSTRACT

In a preventive-action protection system in a motor vehicle having safety devices for reducing the consequences of accidents, driving state data are acquired in a driving state sensor system, and are monitored at least with respect to a braking torque request by the driver. At least the braking torque request is evaluated in a braking request evaluation device, and is used to detect a state of emergency braking. When a state of emergency braking is present at least one of the safety devices is triggered. The braking torque request is acquired by at least two independent sensors and the signals of these two sensors are evaluated in parallel in the braking request evaluation means and are used to detect a state of emergency braking.

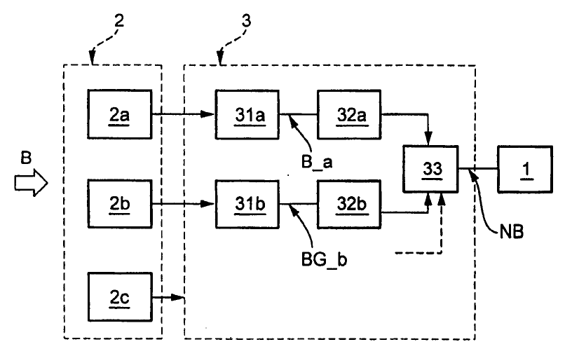

This application is a national stage of PCT International Application No. PCT/PCT/EP2005/011915, filed Nov. 8, 2005, which claims priority under 35 U.S.C. § 119 to German Patent Application No. 10 2004 062 487.9 filed Dec. 24, 2004, the disclosure of which is expressly incorporated by reference herein.

### BACKGROUND AND SUMMARY OF THE INVENTION

The invention relates to a preventive-action protection system in a motor vehicle that has safety devices for reducing the consequences of accidents.

Protection systems which are activated prevently in anticipation of a possible collision and use what is referred to as a pre-crash phase (a period of time starting from the detection of a high probability of a collision by appropriate detection systems in the vehicle, until the actual impact) to enhance the vehicle occupant protection by means of additional safety measures. Such systems, which lessen the severity of an accident, are referred to as preventive-action protection systems or so-called PRE-SAFE™ systems.

In order to detect possible accident situations, preventive-action protection systems make use of information which is made available by various sensor devices of the motor vehicle. (The sensor devices here may also be a component of an electronic driving stability program and/or a component of an inter-vehicle distance sensor system.) Depending on the detected situation, conclusions are drawn about a possible accident, and appropriate measures, relating to restraint systems for vehicle occupants and possibly protection devices for other parties in an accident, such as pedestrians, are initiated in order to condition the vehicle for the imminent accident.

Such a method for actuating a reversible vehicle occupant protection means in a motor vehicle is described by way of example in German patent document DE 101 21 386 C1. The motor vehicle here has a reversible vehicle occupant protection system which can be activated before a collision time and thus moved into an effective position. For this purpose, a sensor system is used to acquire driving state data which is monitored for any possible emergency braking, any possible oversteering and any possible understeering. If emergency braking, oversteering and/or understeering are detected, the vehicle occupant protection system is activated, in which case further conditions may be provided for the triggering operations. The sensor system for acquiring the driving state data can comprise a steering angle sensor, a pedal travel sensor, a brake pressure sensor, a wheel speed sensor, an acceleration sensor and a yaw rate sensor.

An emergency braking operation occurs if a braking process takes place with at least one feature which indicates a hazard situation or emergency situation. The state of emergency braking is determined by using at least one of the parameters of brake pressure, speed of the activation of the brake pedal and speed of the withdrawal of pressure from the accelerator pedal to evaluate the braking process. As an alternative to emergency braking which is brought about by the driver (driver reaction) it is possible to bring about emergency braking on the basis of sensing of the surroundings.

According to German patent document DE 101 21 386 C1 mentioned above, the state of emergency braking can be detected by means of an intervention by a brake assistance system in the vehicle movement dynamics by virtue of the fact that, for example, an information signal which is transmitted from the brake assistance system to a data bus is used to detect the state of emergency braking. Triggering of the safety devices of the protection system is then coupled to the algorithm of the brake assistance system. The signal of the brake light switch which is also made available on the data bus of the vehicle can also be used to confirm (check the plausibility of) the detection of the state of emergency braking. With this redundancy in the detection of an emergency braking operation, the reliability of a decision when the protection system is triggered is increased.

A further preventive-action protection system is disclosed in German patent document DE 100 29 061 A1. In order to detect a state of emergency braking, the time gradient, which corresponds to the time derivative, of the brake pressure generated by the brake pedal is evaluated, and the fact that a threshold value is exceeded by the brake pressure gradient is indicative of an emergency braking state. The pedal travel or the pedal force can also be measured as a representative of the measured brake pressure.

In order to check the plausibility of the decision, the brake pressure is also submitted to evaluation in parallel to the brake pressure gradient by comparing the brake pressure with a brake pressure threshold value and comparing the time when the threshold was exceeded by the measured brake pressure with a predefined time period. This is intended to separate out brief braking situations in which the brake pressure gradient is above the brake pressure gradient threshold but the braking request is not present for long enough with an intensity above the threshold.

One object of the invention is to provide an improved preventive-action protection system of the type described above.

This and other objects and advantages are achieved by the protection system according to the invention, which provides a relatively high degree of reliability in detecting an emergency braking operation requested by the driver, by virtue of the fact that the evaluation can be supported on at least two independent sensors for sensing the braking torque request of the driver. In particular, the pressure in the brake system or master brake cylinder can be acquired with a first sensor and the pedal travel can be measured with a second sensor, in particular a pedal travel sensor, pedal force sensor or diaphragm travel sensor.

The methods known from the prior art support the detection of a state of emergency braking solely on the evaluation either of the activation of the brake pedal or on the evaluation of the brake pressure which has been built up in the brake system or master brake cylinder.

Basically, in order to sense the braking torque request the brake pressure in the master brake cylinder can be used as a measured variable to detect an emergency braking request by the driver. However, the brake pressure in the master brake cylinder reacts extremely slowly to a sudden braking torque request by the driver and is therefore less suitable for detecting rapid changes in the driver's request.

In a conventional hydraulic brake system, a diaphragm travel sensor senses both the pedal movement and the diaphragm movement of the brake booster. The diaphragm travel sensor thus reacts much more directly to the pedal travel than the brake pressure in the master brake cylinder. In an electrohydraulic brake system (brake-by-wire system) a pedal travel sensor picks up the activation of the brake pedal directly. If one is present, it is therefore alternatively or additionally also possible to use a diaphragm travel sensor or pedal travel sensor to sense the braking torque request.

In one embodiment of the invention, the signal of the first sensor (brake pressure) and the signal of the second sensor (pedal travel) are conditioned in each case by differentiation according to time with respect to a signal for the braking torque request speed, and the two signals are each fed to a threshold interrogator. The results of these threshold interrogators are used to detect the state of emergency braking in a logic element if at least one braking torque request speed exceeds a threshold for an emergency braking operation to be detected. Depending on whether rapid, or preferably ensured, triggering is desired, the logic element can be embodied as an OR element or as an AND element. The parallel interrogation of the interrogation of the braking torque request speed which is supported on different sensors also permits the conditions for the detection of an emergency braking operation to be predefined in a differentiated fashion because the sensors 2a, 2b pick up the pedal activation in different ways.

If a combined evaluation of a braking torque request and of a braking torque request speed is provided in the prior art, the signal for the braking torque request speed is always formed by taking the time derivative of the signal for the braking torque request, so that both are supported on the same sensor signal.

In a second embodiment (not illustrated in more detail in the exemplary embodiment) the signal of the first sensor (brake pressure) is conditioned to form a signal for the braking torque request, and the signal of the second sensor (pedal travel) is conditioned to form a signal for the braking torque request speed, and the two signals are each fed to a threshold interrogator whose results are used to detect the state of emergency braking in a logic element.

In this embodiment, using the signal of a pedal travel sensor or diaphragm travel sensor has the advantage that at the beginning the pedal travel represents the driver's request directly and without faults because, (due to a delayed reaction of the backpressure in the brake system on the activation of the brake) the pedal does not yet have to be depressed against a high resistance. A reaction of the brake system against the pedal force does not occur until later in the course of the activation. The signal of a pedal travel sensor or diaphragm travel sensor is also possibly unusable during an ABS control intervention owing to the pulsating reaction on the brake pedal. In particular, pedal travel measurement or diaphragm travel measurement is therefore suitable for early sensing of a rapid braking torque request by the driver.

However, the pressure in the master brake cylinder is a very suitable variable for sensing a slow and enduring braking torque request because said pressure follows the activation of the brake pedal with a certain degree of inertia. As a result many brief braking situations can be separated out because a sufficient brake pressure is not generated.

Accordingly, the selected combination in which the evaluation of slow and enduring braking torque requests is supported on the brake pressure in the master brake pressure cylinder, while the braking torque request speed is acquired from the derivation of a signal of the pedal travel sensor or diaphragm travel sensor over time, is advantageous.

If there is a reproducible relationship between the pedal travel and a pedal restoring force, a pedal force sensor can be used instead of a pedal travel sensor. However, if the restoring force of the brake pedal comes about due to a reaction of the backpressure in the brake system, the relationship is no longer unambiguous. In this case, the pedal force no longer corresponds to the brake pressure in the master brake cylinder.

In addition to the known safety devices which can be triggered in a preventive fashion, such as the reversible seat belt pretensioner of a seat belt, there are a series of further vehicle occupant protection means which can be actuated and which produce a restraining effect or an energy-absorbing effect in order to protect a vehicle occupant in the event of a collision. Examples of such vehicle occupant protection means are movable impact elements, cushions and headrests whose size, hardness, shape and position can be changed by means of an actuation process. In addition to these vehicle occupant protection means, further safety devices can be provided for reducing the severity of an accident. Such safety devices reduce the consequences of an accident for a vehicle occupant by actuating electrically adjustable assemblies, for example an electric seat adjustment device or an electric adjustment device for vehicle openings (window lifter, sunroof closing system) or door locks, which were originally provided for comfort purposes.

In order to lessen the consequences of accidents, it is also possible to provide safety devices which can be actuated in motor vehicles and which also serve to protect other parties in a collision, in particular to protect pedestrians and cyclists. Examples of this are adjustable engine hoods, movable bumpers and impact elements with adjustable hardness on the outer skin of the vehicle. Further protection means which can be actuated are the ride level controller and the braking and steering system by means of which an impact can be optimized in the direction of less severe injury to the vehicle occupants and/or the parties in a collision. These protection means are also to be understood below as safety devices within the sense of the present invention.

Other objects, advantages and novel features of the present invention will become apparent from the following detailed description of the invention when considered in conjunction with the accompanying drawings.

### BRIEF DESCRIPTION OF THE DRAWINGS

The single FIGURE shows a block circuit diagram of an exemplary embodiment of the preventive-action protection system according to the invention in a motor vehicle.

### DETAILED DESCRIPTION OF THE DRAWINGS

In order to actuate the preferably reversible safety devices 1, driving state data are acquired in the driving state sensor system 2, and are monitored at least with respect to a braking torque request B by the driver. The driving state sensor system 2 comprises a first sensor 2a for measuring the pressure in the master brake cylinder and a second sensor 2b for measuring the pedal travel. In addition, the driving state sensor system can use further sensors 2c to acquire further data, for example longitudinal or transverse acceleration of the vehicle, activations of the accelerator pedal or tiredness of the driver which can influence the subsequent processing and logic operation performed on the signals.

In the braking request evaluation means 3, at least the braking torque request B is evaluated and used to detect a state of emergency braking. When a state of emergency braking NB is present, at least one of the safety devices 1 is triggered.

In the braking request evaluation means 3, the signals of the first sensor 2a and of the second sensor 2b are conditioned in parallel in respectively assigned conditioning stages 31a, 31b, with the signal of the second sensor 2b being differentiated over time. The signals which are conditioned in this way for the braking torque request B_a and the braking torque request speed BG_b are each fed to a threshold interrogator 32a, 32b. The results of the threshold interrogators 32a, 32b are fed to a logic element 33 in which the presence of a state of emergency braking NB is determined, possibly using further parameters.

In this way it is possible, for example, to logically combine the signal for the braking torque request speed BG_b (which is known to be a basis for the detection of an emergency braking situation) with the result of a threshold interrogator for the signal B_a of a braking torque request by means of an AND logic operation within a brief time window or after the signal has been present for a short time. It is thus possible to ensure not only that a rapid braking torque request has been present, but also that such braking torque request leads to a subsequently acting brake pressure with which brief braking situations are separated out. This embodiment is presented in the International Patent Application EP2004/012685 on which the priority is based and which is incorporated herein by reference.

In a further application, the signal for the braking torque request speed BG_b, which is known to be a basis for the detection of an emergency braking situation, is logically combined with the result of a threshold interrogator for the signal B_a of a braking torque request by means of an OR logic operation and including the longitudinal deceleration of the vehicle. It is thus possible to ensure not only that a rapid braking torque request leads to the detection of an emergency braking operation but also that a high brake pressure is present if said brake pressure does not lead to a longitudinal deceleration of the vehicle, or leads to a small longitudinal deceleration of the vehicle. In this case, an excessively low coefficient of friction between the tire and carriageway is present, for example due to slippery conditions, which also leads overall to the detection of an emergency braking operation NB if the brake pressure requested by the driver exceeds a threshold (panic braking). This embodiment is presented in an application by the applicant which was submitted on the same date and which is incorporated herewith by reference.

The thresholds in the threshold interrogators 32a, 32b for the braking torque request or the braking torque request speed can be influenced by driving state data. In particular, the thresholds can be dependent on a signal for the braking torque request or its speed. Alternatively in the case of low driving speeds below approximately 30 km/h the thresholds can be raised in order to effectively suppress incorrect triggering or undesired triggering in this speed range. At speeds above approximately 80 km/h, the thresholds can be lowered because the driver has empirically been found to depress the brake more sensitively at relatively high speeds. It is also conceivable to influence thresholds as a function of the transverse acceleration. In particular, the thresholds in a medium transverse acceleration range could be lowered.

Instead of performing logic operations (AND, OR) on the results of the various evaluations or interrogations a comparable behavior of the protection system can be obtained by replacing the binary logic in a manner known per se by a fuzzy logic. For example, an overall criticality for the longitudinal dynamics which is dependent on a multifactorial basis on the vehicle data can be formed, said overall criticality assuming a value between 0 . . . 1 and having to overcome a fixed threshold at, for example, 0.8 for a safety device to be triggered.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-7. (canceled)

8. A preventive-action protection system for a motor vehicle having safety devices for reducing the consequences of accidents, wherein:
driving state data are acquired in a driving state sensor system, and are monitored at least with respect to a braking torque request from a driver of the vehicle;
at least the braking torque request is evaluated in a braking request evaluation means (3) and is used to detect a state of emergency braking;
when a state of emergency braking is present, at least one of the safety devices is triggered;
the braking torque request is acquired by means of at least two independent sensors; and
signals of the at least two sensors are evaluated in parallel in the braking request evaluation means, and are used to detect a state of emergency braking.

9. The protection system as claimed in claim 8, wherein:
the pressure in the brake system or master brake cylinder is acquired by a first of the at least two sensors; and
pedal travel is measured by a second of the at least two sensors.

10. The protection system as claimed in claim 9, wherein the second sensor is one of a pedal travel sensor, pedal force sensor and diaphragm travel sensor.

11. The protection system as claimed in claim 9, wherein the signals of the two sensors are conditioned in the braking request evaluation means (3) to form signals for one of the braking torque requests.

12. The protection system as claimed in claim 11, wherein:
the signal of the first sensor is conditioned to form a first signal for the braking request speed; and
the signal of the second sensor is conditioned to form a second signal for the braking torque request speed; and
the two signals are each fed to a threshold interrogator whose results are used to detect the state of emergency braking in a logic element.

13. The protection system as claimed in claim 11, wherein:
the signal of the first sensor is conditioned to form a signal for the braking torque request; and
the signal of the second sensor is conditioned to form a signal for the braking torque request speed; and
the two signals are each fed to a threshold interrogator whose results are used to detect the state of emergency braking in a logic element.

14. The protection system as claimed in claim 12, wherein:
the signal of the first sensor is conditioned to form a signal for the braking torque request; and
the signal of the second sensor is conditioned to form a signal for the braking torque request speed; and
the two signals are each fed to a threshold interrogator whose results are used to detect the state of emergency braking in a logic element.

15. The protection system as claimed in claim 12, wherein thresholds in the threshold interrogators are dependent on further driving state data.
